(19) United States
(12) Patent Application Publication
(10) Pub. No.: US 2022/0353215 A1
(43) Pub. Date: Nov. 3, 2022

(54) OWNER IDENTIFICATION AND COMMUNICATION

(71) Applicant: Unlost LLC, Excelsior, MN (US)

(72) Inventors: Brian Paul Wallenfelt, Chanhassen, MN (US); Anthony Todd Hessburg, Minnetrista, MN (US); Jeremy Wolfe, Coon Rapids, MN (US)

(21) Appl. No.: 17/745,860

(22) Filed: May 16, 2022

Related U.S. Application Data
(60) Provisional application No. 63/183,626, filed on May 3, 2021.

(51) Int. Cl. H04L 51/04; H04W 12/45; H04W 4/029; G06F 3/0488

(52) U.S. Cl. CPC H04L 51/04; H04W 12/45; H04W 4/029; G06F 3/0488

(57) ABSTRACT

Systems, devices, methods, computer-readable storage media, and electronic apparatuses for owner identification and communication are provided.

### CROSS-REFERENCE TO RELATED APPLICATIONS

This application is related to and claims priority, as appropriate, to U.S. Ser. No. 63/183,626, titled “OWNER IDENTIFICATION AND COMMUNICATION” and filed May 3, 2021, the disclosure of which is hereby incorporated by reference in its entirety.

### BACKGROUND

Personal items are often lost, left behind, or misplaced. Non-limiting examples or personal items include electronic devices (e.g., phones, computers, video game systems, watches), sports equipment, clothing, winter gear, hats, footwear, glasses, keys, wallets, credit cards, backpacks, purses, books, water bottles, mugs, and tumblers. Recovering these lost items may be difficult because the owner may not know where the item was lost. Furthermore, the lost item may be moved to a different location, such as a lost and found.

When a person finds an item that has been left behind by another, there are often few options to find the owner. In many cases, the finder may bring the item to a lost and found or move the item to a location where it is more likely to be seen (e.g., if the owner returns to look for it).

Electronic tracking tags may be placed on some personal items to help locate them if they are lost. These electronic tags may, for example, communicate with smartphones running a specific application that are within a communication range of the electronic tags. The smartphone may then record the location in which it communicated with the tag and share that location with an owner of the tag. While these tags may work well in many situations, there are drawbacks. The tags are often expensive, bulky, and require batteries to operate. The tags may be difficult or impossible to attach to certain types of personal items. The tags may also not be suitable for items that are likely to encounter water or impacts, such as sporting equipment.

Owners may put their name or contact information on an item so a finder can return the item. But this also has limitations. A finder may be able to use a name to contact the owner in an environment with a limited number of people, such as a classroom or youth sporting event. Outside of these limited environments, a name is rarely enough information to help a finder identify the owner. The owner's contact information may be helpful to identify or contact the owner but using the contact information to contact the owner may be inconvenient for a finder, which may in turn reduce the likelihood that a finder will take steps to return the item. Furthermore, some people may not be comfortable with placing their (or their children's) personal information on items that can be seen by anyone out in public. Furthermore, it may be a bad idea to put contact information on certain types of personal items such as keys (e.g., because a finder may be able to find the owner's residence with the contact information and access the residence using the keys). Although most finders will want to do good and help return an item to its owner, providing personal information on the items creates risks for the owner.

### SUMMARY

In general, this disclosure includes systems and methods for identifying and communicating with an owner of an item. In a non-limiting example, the systems and methods provide for anonymous communication that does not reveal the identity of an owner or a finder.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of a system for owner identification and communication.

FIGS. 2-8 are flowcharts of example method performed by at least some implementations of the system of FIG. 1.

### DETAILED DESCRIPTION

This description relates to owner identification and communication. For example, the disclosed technology may allow for communication between a person who finds an item (also referred to herein as a finder) of an item and a person who owns the item (also referred to herein as an owner). In at least some implementations, the communication may occur without revealing the identity of either the owner or finder.

A finder may be able to easily initiate communication using an identification apparatus affixed to the item. For example, the identification apparatus may include an identifier that is usable to initiate communication with the owner. The identifier may be machine-readable, human-readable, or both. In some embodiments, the identifier is a quick response code (a “QR code”).

The identification apparatus may include a vinyl or paper label with an adhesive backing, a plastic card or tag, a metal card or tag, or a cloth label or tag. In some implementations, the labels come in various shapes and sizes that can be applied to different types of items. In some implementations, the identifier may be a plastic tag that is similar to a luggage tag and may be attached to an item with a flexible lanyard. In some implementations, the identifier may be integrated with the item. For example, articles of clothing may include a screen printed or sewn in identifier than can be used as described herein.

Upon entry of the identifier on a communication device, the finder may be able to send a message to the owner. For example, the finder may enter the identifier on a smartphone by scanning the identifier, such as a QR code, affixed to the object. Scanning the identifier may include taking a picture of the identifier, aiming at the identifier while a camera application is active on a smartphone, or aiming at the identifier while an application specifically programmed to read the identifier is active. The smartphone may launch an application associated with the identifier. The application may be an application that is specifically programmed for communicating with an owner associated with an identifier.

The identifier may include one or more of a numeric code, a uniform resource locator, a character string, a binary string, a bar code, a two-dimensional barcode, a QR code, or another type of identifier. The identifier may also include a passive or active radiofrequency identifier tag.

As described above, the code may be entered by scanning the identifier. The code may also be entered using near field communication technology. In some implementations, the code may be entered by a user entering characters using a real or virtual keyboard. The code may also be entered using a speech interface in which a finder speaks the symbols of the code.

Upon entry of the code, an application may launch for communicating with the owner. In some implementations, the application is specifically programmed to communicate with the owner. In some implementations, the application is a general purpose application, such as a web browser, that is usable to communicate with the owner. The application may communicate with a server computing device.

For example, a web browser may send a request for a specific URL to a web server. The URL may be associated with the identifier and allow for communication with the owner. In some embodiments, a specifically programmed application will send a request to an application program interface (API) that includes a code from the identifier. In some implementations, if approved by the finder, the request may include other information in addition to the code, such as an IP address of the finder, geographic information associated with the finder's computing device, and an image of the identifier.

The application may receive a response from the server computing device. In some implementations, the application may receive code (instructions) for rendering a user interface that includes form fields for communicating with the owner. The form fields may include, for example, a message input field, a name input field, and a contact information input field. The response may also include some information about the owner, such as a public profile of the owner or a message from the owner. The public profile and message do not necessarily include any information about the owner's identity or contact information. Instead, the profile may include a picture or a non-specific description. The public profile may also include instructions for returning items or preferred drop-off locations or organizations. In some implementations, the public profile may include information about rewards for returning the item (or for contacting the owner of a lost item).

The response may also include user interface elements to initiate a process for returning the item. An example process includes printing a shipping label or return label. The shipping label may include the owner's name and address. Some owners may not want their names and address shared. As used herein, a return label refers to a label that can be used to return the item but does not include the user's name or address. In some implementations, the return label may include an address for a shipping company (package delivery organization) office. The return label may also include a code that can be read by a shipping company to retrieve delivery instructions or a delivery address. In some implementations, the return label may be directed to a third party such as an organization associated with the user. The return label may include a code name, username, or user number associated with the owner. The shipping label may be a pre-paid shipping label that the owner has paid for (or agreed to pay for) in advance. As described further elsewhere herein, the web server may maintain user profiles and preferences for owners that allow the owner to pre-approve or pre-pay for shipping labels.

Another example process for returning the item is dispatching a courier. An owner may pre-approve dispatching a courier to the finder's location to retrieve and deliver the item (or retrieve and ship the item) to the owner. The courier may be a traditional courier service, an on-demand ride service such as LYFT or LIBER, or a delivery service such as SHYPT™ or DOORDASH™. This process may allow for faster return of items while still maintaining anonymity for both the finder and the owner. Similar to the shipping labels, the owner may pre-approve or pre-pay for the courier service.

Rather than initiating a return process, the owner and finder may simply communicate. For example, the finder may send a message to the owner, and the owner may respond with a message back (a response messages). This process may continue as needed until the owner and finder arrange for return of the item. This communication may be conducted through a messaging platform provided by the server computing device.

In some implementations, the server computing device may include a messaging proxy service that is configured to receive message from either the finder or the owner via email, SMS, or another messaging protocol and transmit the messages to the other of the owner or the finder by the same or a different messaging protocol. For example, the server computing device may generate an email address for a specific conversation between a finder and owner (e.g., this email address may be associated with the server computing device and at a domain name associated with the server computing device). The conversation may be started upon the finder scanning an identifier of an item belonging to the owner. Any emails received by the server computing device at that address from the finder may be forwarded to the owner. Similarly, any emails received by the server computing device at that address from the owner may be forwarded to the finder. In some implementations, the server computing device may generate two email addresses for a conversation: one for emails that will be forwarded to the owner, and one for emails that will be forwarded to the sender. In this manner, the sender and the owner can communicate via email without either party knowing the other party's email address. In some implementations, the owner receives a message as soon as the identifier is scanned. The message may indicate that the identifier was scanned and may include the IP address of the finder's device and an approximate location, which may be inferred from the IP address.

A similar process may be used for text messages, such as SMS. In this process, the server computing device may be configured to receive SMS messages at one or more phone number. Upon a conversation being initiated, a telephone number may be associated with the conversation such that any messages sent to the finder by the server computing device will be sent via the associated number and any messages received from the finder at the associated number will be relayed to the owner. Similarly, a phone number (either the same one or a different one) may be associated with the owner such that any messages sent to the owner by the server computing device will be sent via the associated number and any messages received from the owner at the associated number will be relayed to the finder. The server computing device may, for example, maintain a data structure that maps an incoming phone number and a message source to a destination phone number. When the server computing device receives a message on an incoming phone number, the server computing device will use the incoming phone number and the source phone number to determine a destination phone number. The message will then be relayed (re-transmitted) to the destination phone number. From the finder's and owner's perspectives all messages will be sent to and received from phone numbers associated with the server computing device. In this manner, the finder and owner may communicate with one another via text message without revealing their own phone numbers.

In some implementations, messages are sent to an inbox managed by the server computing device (platform inbox). Users, such as owners and finders, may login to an account on the server computing device to view the message and respond to the messages. When a user receives a message in their inbox, the server computing device may then send a notice to the user via email, SMS, or otherwise according to the user's notification preferences. The notification may include the message content, a portion of the message content, or a link (e.g., a URL) that is usable to access the inbox, view, and respond to messages.

In some implementations, the server computing device or an application on the finder computing device may generate prompts or suggestions for content of the messages sent to the owner. For example, the template may include a message such as “Hi! I found your <item> at <location>.” The template may simplify the process of contacting an owner for the finder as the finder may only need to fill in the blanks (shown here within angle brackets) in the template. In some implementations, the template may prompt the finder to provide location data such as GPS coordinates or an image. For example, rather than describing the item that is found, the finder may simply provide an image. Similarly, rather than describing the location where the item was found, the template may prompt the finder to provide location date (e.g., from a GPS component of the finder computing device or by specifying a location on a map).

In some implementations, the identifiers may be associated with an organization as well as an owner. Example organizations include schools, business, recreational groups, health care facilities, residential facilities/complexes, sports teams, health or fitness clubs, etc. Using schools as an example, some members of a school organization may have permission to view additional information about the owner of an item when the identifier affixed to the item is associated with the school. For example, the server computing device may maintain privileged user accounts for teachers, administrators, and other staff members of the school. When a finder computing device is associated with one of the privileged user accounts, the server computing device may transmit a response that includes information about the owner that would not otherwise be provided, such as the owner's name, classroom, and contact information. Beneficially, this additional information may simplify the process of returning an item to its owner when the item is found by a trusted member of the organization. Other user accounts (standard or non-privileged accounts) would not receive this additional information. In some implementations, the server computing device may provide different information to other user accounts (standard or non-privileged accounts) such as instructions to drop off the found item at a specific location within the school. In some implementations, non-privileged users receive only a form to communicate with the owner. In some implementations, finder computing devices that are not associated with a user account (or not associated with a user account that is associated with the organization) may receive only a form to communicate with the owner.

Organizations may lend items to members. For examples, schools may lend instruments or computing devices to students. The organizations may own the items but provide custody of the items to students so that the students may use the items for a specific time period (e.g., a semester, a school year, a sport season). The organization may affix an identification apparatus to the item. In some implementations, the server computing device may generate a user interface that an administrator can use to specify contact information (or one or more user accounts) that should be notified when the identifier on the identification apparatus is scanned. Over time, the administrator may use the interface to change the contact information or user accounts associated with the identifier (e.g., as the item is lent to different students).

In some implementations, when an owner scans an identifier associated with their own account, the server computing device may respond with information that confirms that the owner is associated with the identifier. Beneficially, an owner may use this information to indicate (prove) that he or she is the owner of the item.

In some implementations, delivery administrator user accounts associated may be presented with additional information when scanning an identifier. For example, a delivery administrator user account may be used for order fulfillment. When a delivery administrator user account scans an identifier, delivery fulfillment instructions may be presented. The delivery fulfillment instructions may include a shipping address. Beneficially, this information may be useful in making sure identification apparatuses are shipped to the correct location. In some implementations, this additional information is only presented if the identifier has not yet been registered (or activated) by an end user.

In some implementations, after an item is returned, the owner may mark the item returned. For example, the user interface for communicating with the finder may include a user-actuatable control to mark an item returned. Upon the item being marked returned, a user interface may be generated for the owner to send a thank you message to the finder. In some implementations, the owner may include a gift/reward with the thank you note. For example, the gift may include an electronic gift card. The electronic gift card may be sent to the finder via email by the server computing device without sharing the finder's email address with the owner. In some implementations, the owner may pre-specify a gift for returning a lost item. In these implementations, the reward may be transmitted to the finder in response to the owner indicating that the item has been found. In some implementations, the reward may be transmitted to a finder upon the finder scanning the code and transmitting a GPS location associated with the item to the server computing device.

Additionally, in some implementations, the server computing device may keep records associated with the user accounts. These records may include the number of times the user account has found or returned items. In some implementations, the user accounts may include a point total. The server computing device may award points to a finder for completing various steps. For example, a first amount of points may be awarded for scanning an identifier belonging to someone else. An additional amount of points may be awarded for other activities such as sending a message, sending a GPS coordinate, sending an image, or having the owner mark an item returned.

In some implementations, the owner may provide additional points as a reward. In some implementations, the server computing device may generate a list of users with the most points overall or during a specific time period. In some implementations, prizes may be awarded to users who have earned the most points during a specific time period. Prizes may also be awarded for earning at least a specific amount of points. These prizes may be real world prizes, gift certificates, credits for purchasing identifiers, or digital items. Examples of digital items include badges or other types of visual identifiers that may be displayed on a user profile. In some implementations, the digital items include non-fungible tokens. In some implementations, users may purchase or earn points.

Some implementations include an electronic payment capability or an integration with a third-party electronic payment service (e.g., PayPal, Venmo, Cash App, or cryptocurrency payment services). The owner may send an electronic payment to the finder to thank the finder for contacting the owner or returning the item. In some implementations, the owner may send an electronic payment to the finder as an agreed payment for delivering the lost item to specified location to return it. The owner and the finder may send messages back-and-forth to reach an agreement about whether there will be any payment and how much the payment will be (e.g., Owner: “Hey, I'll send you $5 to bring my item over to the nearest FedEx® store”). In some implementations, a smart contract may be generated to perform payment or issuance of a reward upon delivery of the item to a shipping location or depositing the item in a lost and found or with a courier, etc.

In some implementations, an owner may mark an item as lost and may provide a last known location of the item (e.g., the last known location may include GPS coordinates, an address, or a point selected on a map). The owner may provide a description or upload an image of the lost item. In some implementations, the owner may also include a reward. These items (or visual indicators representing the items) that have been marked as lost may then be displayed on a user interface that includes a map. The items may, for example, be displayed at locations on the user interface that represent the locations entered by the owners.

In some implementations, lost items entered by multiple users (owners) may be displayed on the same user interface. Beneficially, users interested in finding lost items (and potentially collecting rewards or points) may use the map to identify geographic areas in which to search and what to search for. In some implementations, a computing device may be configured to provide alerts to users when the device is within a predetermined threshold of a location of a lost item (e.g., based on a GPS position of the user's device and the last known location of the lost item entered by the owner).

In some implementations, a single user account may be associated with multiple identifiers. The identifiers may, for example, be placed on different items and the user may define different behaviors for each of the identifiers. For example, the user may pre-approve paying for a courier service to collect items associated with at least one of the identifiers. The owner may place these identifiers on more expensive or indispensable items such as phones, computers, or other electronic devices. For other identifiers, the owner may choose to not preapprove courier service and may instead rely upon the communication platform to retrieve these items. The owner may choose to apply these identifiers to items that are less expensive, easier to replace, or easier to go without for a period of time, such as water bottles, sports equipment, or clothing items.

In some implementations, an owner may include a description or image of an item (or items) associated with an identifier. This image or description may be helpful to encourage a finder to return the item. The image or description may also help an owner understand what item has been found and to what item a message from a finder refers. In some implementations, an application may recommend return options based on the image or the description. For example, machine learning or other techniques may be used to recognize images of phones or computers or descriptions that relate thereto. When those items are recognized, the application may recommend pre-approving courier service, shipping labels, or other options for the items. The application may, for example, run on an owner computing device or a server computing device.

In some implementations, user accounts associated with a courier service may have access to additional information after scanning an identifier (e.g., the destination address for the associated item). Similar information may be provided when an identifier is scanned by a user account associated with a shipping company. Some implementations, allow the user account associated with the owner to define which information (if any) is provided to courier and shipping company user accounts.

Furthermore, some implementations, allow a user to transfer an identifier to another user account (e.g., to represent transfer of ownership of the items to which the identifier is affixed).

In some implementations, the communication may be anonymous such that the finder does not know the identity of the owner and the owner does not know the identity of the finder.

In some implementations, the identification device may include a scannable identifier (e.g., a QR code) and a transceiver (e.g., a Bluetooth transceiver). The transceiver may communicate with one or more computing devices that are in proximity to the identification device. The computing devices may receive a wireless transmission that includes an identifier (which may be the same as or different than the scannable identifier) associated with the identification device. The computing device may record a location (e.g., determined by a GPS component of the computing device) when the identifier is received from the identification device. This identifier and the location may then be transmitted to a server computing device. The owner of the identification device may then be able to access the server to determine where the identification device's location was most recently recorded. If the identification device is able to communicate with many (e.g., thousands or millions) of computing devices this information may be helpful for owners to locate the identification device. For example, the transceiver of the identification device may communicate with any smartphone running a specific operating system or that has a specific application installed. The scannable identifier may supplement the information provided by the transceiver so that a finder can initiate communication with an owner as described above (e.g., to allow a finder to communicate with the owner without using the transceiver).

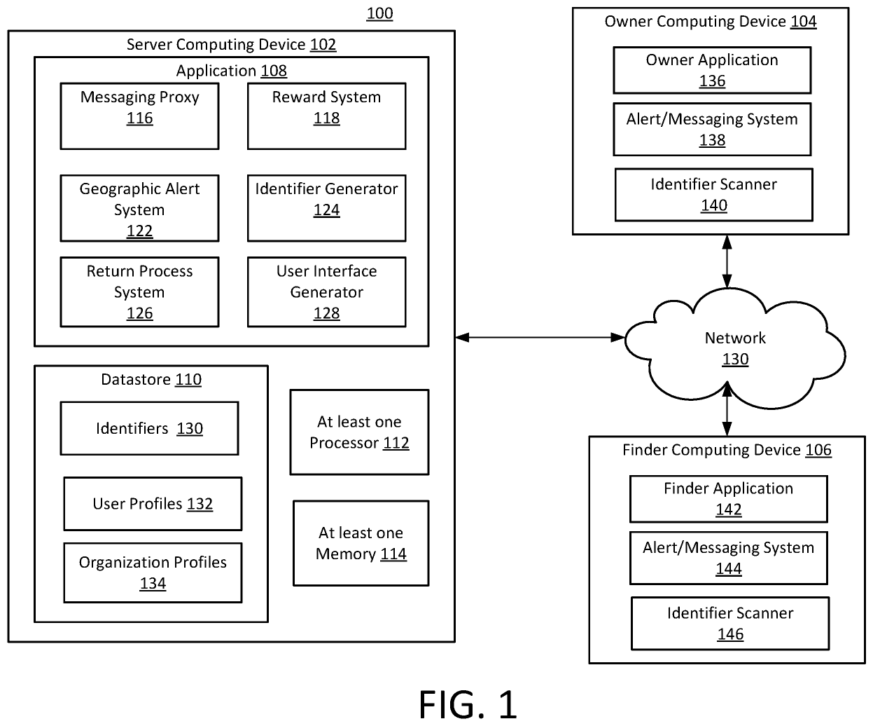

FIG. 1 is a block diagram of a system 100 for owner identification and communication. The system 100 includes a server computing device 102 having an application 108, a datastore 110, at least one processor 112, and at least one memory 114. In some implementations, the system 100 also includes one or more of an owner computing device 104 and a finder computing device 106. Although the owner computing device 104 and the finder computing device 106 are shown as separate computing diagrams in FIG. 1, in some implementations, a single computing device can perform the functions of both the owner computing device 104 and the finder computing device 106. The server computing device 102 may communicate with the owner computing device 104 or the finder computing device 106 over a network 130.

The application 108 may be accessed directly by a user of the computing device 102. In other implementations, the application 108 may be running on the computing device 102 as a component of a cloud network where a user accesses the application 108 from another computing device over a network, such as the network 130. For example, the application 108 may be a web-based application that can be accessed from a web browser running on another computing device.

In one implementation, the application 108 is an owner identification and communication application. For example, the application 108 may facilitate communication between the finder computing device 106 and an owner computing device 104 based on an identification apparatus affixed to an item. For example, a user of the finder computing device 106 (the finder) may scan the identification apparatus, causing the finder computing device 106 to send a request to the server computing device 102. In response to the request, the server computing device 102 may send a response to the finder computing device 106 that is specific to the scanned identifier and is usable by the finder computing device 106 to send a message to the owner computing device 104 (e.g., via the server computing device 102).

The application 108 may include a messaging proxy 116, a reward system 118, a geographic alert system 122, an identifier generator 124, a return process system 126, and a user interface generator 128.

The message proxy 116 may, for example, act as a proxy for messages from finders to owner (or finder computing device 106 to owner computing device 104) and vice versa. The message proxy 116 may support various messaging protocols. Non-limiting examples of messaging protocols supported by some implementations include email (e.g., SMTP) and text message (e.g., SMS, MMS).

The reward system 118 may, for example, allow owners to send rewards to finders. For example, an owner may use the owner computing device 104 to transmit an electronic gift card, non-fungible token (NFT), or another type of reward to the finder via the finder computing device 106. The reward system 118 may also reward finders with points when a finder performs various actions such as contacting the owner of an item.

The geographic alert system 122 may generate a graphic representation of last known geographic locations of items that have been marked as lost. In some implementations, the graphic representation may be a map. In some implementations, the geographic alert system 122 may send messages to the finder computing device 106 in response to the finder computing device 106 entering with a specific area or specific distance of a location where an owner has indicated that an item was lost.

The identifier generator 124 generates identifiers. In some implementations, the identifiers are generated for a specific user. In some implementations, the identifiers are not generated for a specific user and are instead not initially associated with any user. A user of the owner computing device 104 may take steps to register the unassociated identifier. For example, the user may scan an identifier that is not associated with a user account and in response be prompted claim the identifier. In some implementations, the user may then need to enter a PIN or other information to claim the identifier. As noted previously, a user account may be associated with multiple identifiers. A user may submit an order for identification apparatuses. In some implementations, the ordered identification apparatuses will include one of the identifiers that are already associated with the user account (e.g., a default identifier or the user may specify which of multiple identifiers to use). In some implementations, a new identifier will be generated and included on the identification apparatuses. The new identifier may be associated with the user account at the time of generation or may need to be claimed (e.g., as described above using a PIN or otherwise) at a later point. Beneficially, the claiming process may be used when a user orders identification apparatuses as gifts for another user.

The return process system 126 may initiate various return processes that an owner has authorized. For example, if an owner has pre-approved sending a courier to retrieve a found item, the return process system 126 may communicate with a courier or ride hailing system to send a driver to retrieve the item at a location specified by the finder. In some implementations, the return process system 126 may generate a shipping label or shipping instructions for returning an item.

The user interface generator 128 may generate various user interfaces through which users may interact with the system 100. For example, the user interface generator 128 may generate a user interface which is provided to the owner computing device 104 or the finder computing device 106 for presentation to the user. The user interface generator 128 may generate user interfaces using a combination of HTML, XHTML, CSS, JavaScript, or other technologies.

The datastore 110 is a data storage system and may include one or more file systems and databases. In this example, the datastore 110 includes identifiers 130, user profiles 132, and organization profiles 134.

The identifiers 130 may be codes or other unique values. An identifier may be associated with a user profile stored in the user profiles 132. An identifier may also be associated with an organization profile stored in the organization profiles 134. In some implementations, an identifier is associated with information/data about an item associated with the identifier such as an image, description, return instructions or preferences (e.g., authorization to start a courier return process or shipping label return process).

The user profiles 132 include information about users of the system 100. For example, the user profiles may include contact information and preferences for the user. The user profiles 132 may also include a name, username, shipping address, images, or description that the user has provided. In some implementations, the user profile may include various privacy preferences that specify which, if any, information from a user profile should be shared with a finder. The user profiles 132 may include convenient drop off locations for the user. The user profiles 132 may also be associated with one or more of the organization profiles 134. The associations with the organization profiles may indicate locations for dropping off/returning items. For example, if the user profile is associated with an organization profile for a fitness club, a finder may be encouraged to deliver the item to a lost and found at the fitness club.

The organization profiles 134 may represent various organizations such as schools, sports clubs, fitness centers, businesses, and other types of organizations. As noted previously, the organizations may be associated with identifiers or user profiles. In some implementations, at least some of the users associated with an organization may have privileged access to identifiers associated with the organization. These privileged users may be able to access additional information about an owner of the identifier. This information may simplify returning the item to the owner while still preserving the owner's privacy with respect to other users who do not have privileged access with the organization. For example, a school organization might provide privileged access to teachers, allowing teachers to view the name and classroom of a student who owns an item by scanning the identifier. The organization profiles 134 may also include other information such as a name, description, one or more locations, and return instructions.

The owner computing device 104 is a computing device used by the owner of an item. The finder computing device 106 is a computing device used by the finder of an item. Both the owner computing device 104 and the finder computing device 106 may be any type of computing device including a smartphone.

The owner computing device 104 includes an owner application 136, an alert/messaging system 138, and an identifier scanner 140.

The owner application 136 is an application that allows an owner to communicate with a finder and to manage identifiers and account information. In some implementations, the owner application 136 is a web application displayed by a web browser running on the owner computing device 104. In some implementations, the owner application 136 is an application that runs separately from a web browser.

The alert/messaging system 138 is a system for receiving/sending messages and alerts from/to the server computing device 102 or the finder computing device 106. In at least some implementations, messages to/from the finder computing device 106 pass through the server computing device 102. The alert/messaging system 138 may be an email application or a text messaging application. In some implementations, the alert/messaging system 138 may be a notification system of another application that is configured to receive push notifications.

The identifier scanner 140 is a device for scanning an identifier on an item or identification apparatus affixed to the item. In some implementations, the identifier scanner 140 may include a camera and a QR code reader application. In some implementations, the identifier scanner may include a near field communication device. In some implementations, an owner may scan an identifier to register (claim) the identifier. The owner may also scan an identifier affixed to an item to demonstrate ownership of the item (e.g., the owner application 136 may display an indication that the owner is associated with the scanned identifier).

The finder computing device 106 includes a finder application 142, an alert/messaging system 144, and an identifier scanner 146. The alert/messaging system 144 may be similar to the alert/messaging system 138 of the owner computing device 104 and the identifier scanner 146 may be similar to the identifier scanner 140 of the owner computing device 104. The finder may scan an identifier affixed to an item to initiate a return process for the item or to begin communicating with the owner.

The finder application 142 is an application that allows a finder to communicate with an owner. For example, the finder application 142 may allow a finder to send a message to an owner after scanning an identifier. The finder application 142 may also display maps or alerts of nearby items that have been marked as lost. In some implementations, the finder application 142 is a web application displayed by a web browser running on the finder computing device 106. In some implementations, the finder application 142 is an application that runs separately from a web browser.

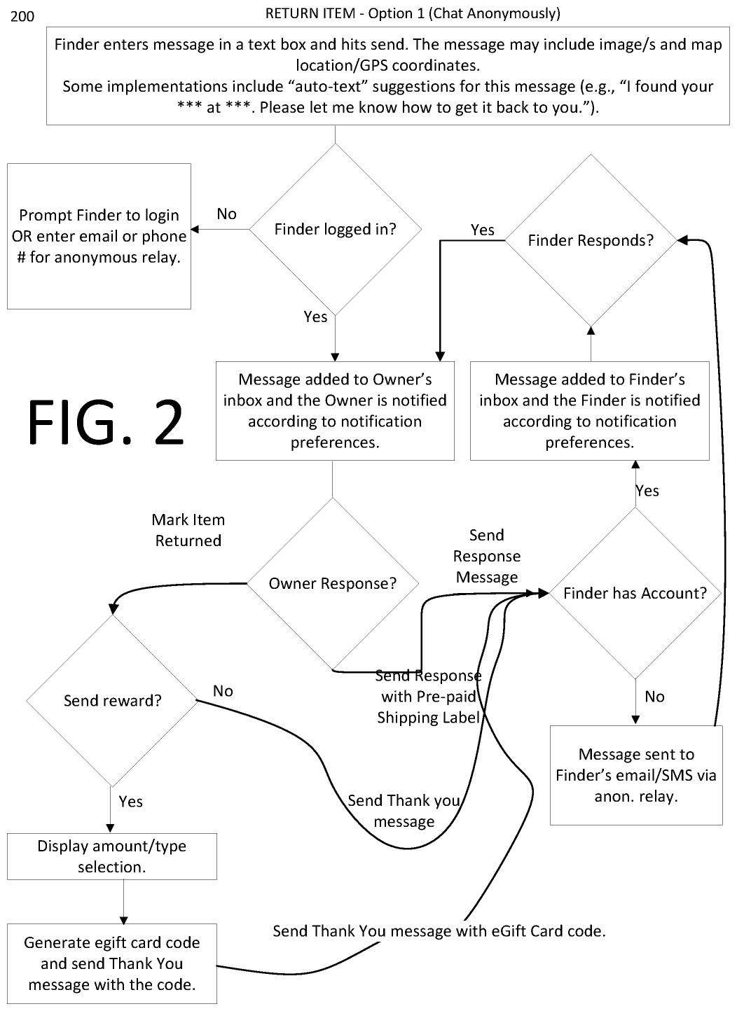

FIG. 2 is a flowchart illustrating an example process 200 for returning an item in accordance with implementations described herein. In this process, the finder and the owner engage in an anonymous chat. This process 200 may begin after a finder finds an item with an identifier (e.g., a QR code) and scans the identifier with a finder computing device. Scanning the identifier may include pointing a camera of the finder computing device at the QR code to read a URL and then causing a web browser on the finder computing device to access the URL. The web browser may then display a form associated with the identifier.

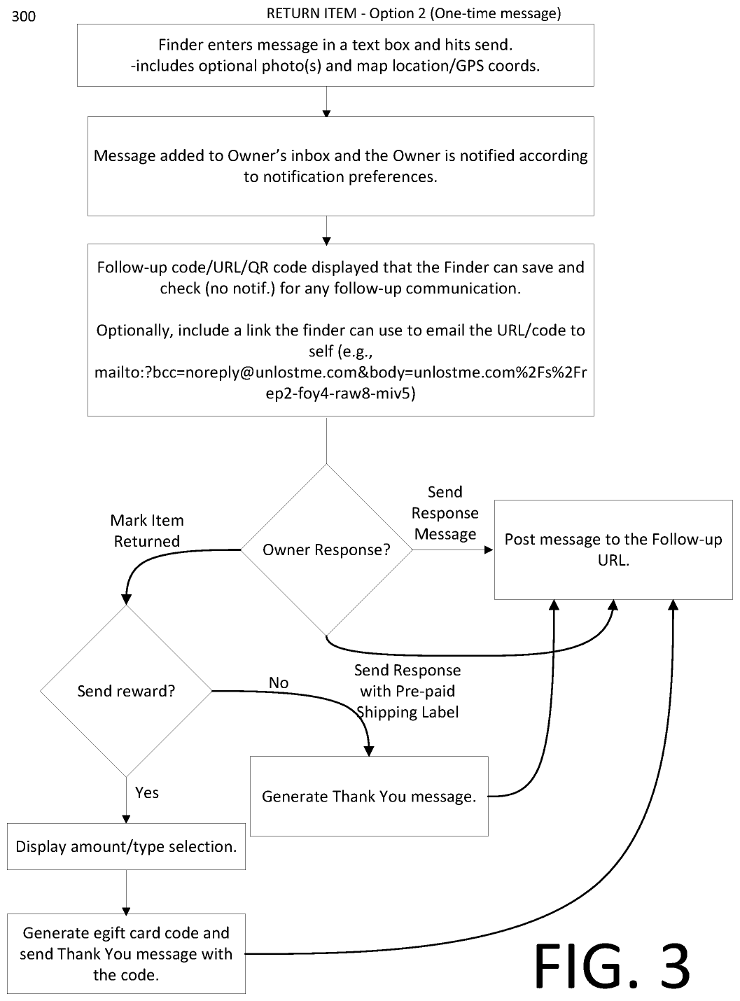

FIG. 3 is a flowchart illustrating an example process 300 for returning an item in accordance with implementations described herein. In this process, the finder sends a one-time message to the owner. This process 300 may begin after a finder finds an item with an identifier (e.g., a QR code) and scans the identifier with a finder computing device. Scanning the identifier may include pointing a camera of the finder computing device at the QR code to read a URL and then causing a web browser on the finder computing device to access the URL. The web browser may then display a form associated with the identifier.

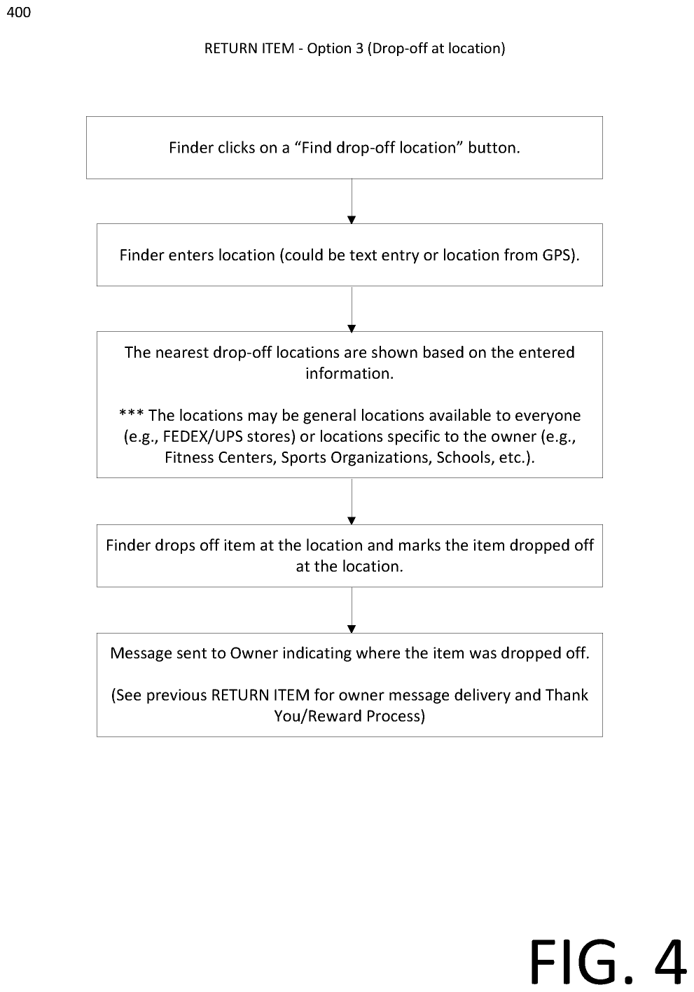

FIG. 4 is a flowchart illustrating an example process 400 for returning an item in accordance with implementations described herein. In this process, the finder drops the item off at a specified drop-off location. This process 400 may begin after a finder finds an item with an identifier (e.g., a QR code) and scans the identifier with a finder computing device. Scanning the identifier may include pointing a camera of the finder computing device at the QR code to read a URL and then causing a web browser on the finder computing device to access the URL. The web browser may then display a web page or form associated with the identifier. The web page may include a “find drop-off location” button.

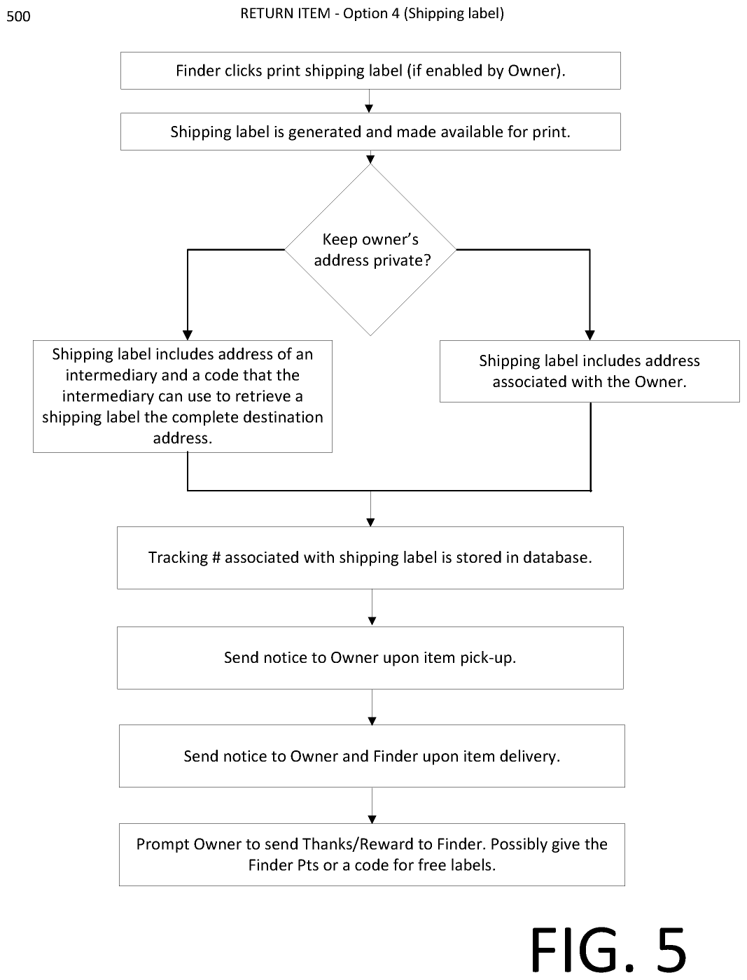

FIG. 5 is a flowchart illustrating an example process 500 for returning an item in accordance with implementations described herein. In this process, the finder ships the item back to the owner. This process 500 may begin after a finder finds an item with an identifier (e.g., a QR code) and scans the identifier with a finder computing device. Scanning the identifier may include pointing a camera of the finder computing device at the QR code to read a URL and then causing a web browser on the finder computing device to access the URL. The web browser may then display a web page or form associated with the identifier. The web page may include a “print shipping label” button.

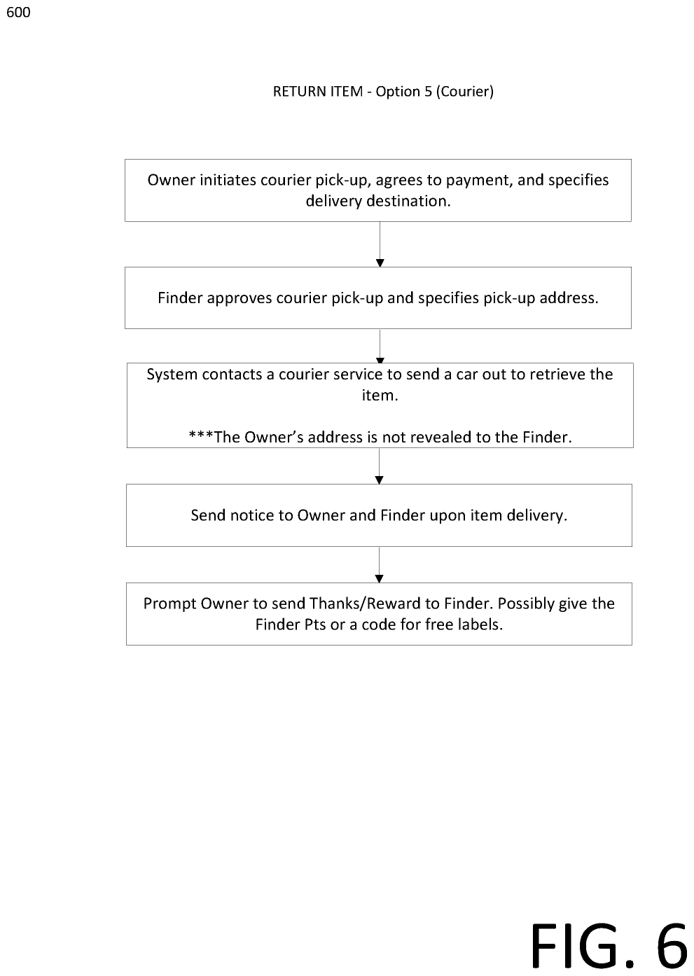

FIG. 6 is a flowchart illustrating an example process 600 for returning an item in accordance with implementations described herein. In this process, the finder returns the item to the owner using a courier or similar service. This process 600 may begin after a finder finds an item with an identifier (e.g., a QR code) and scans the identifier with a finder computing device. Scanning the identifier may include pointing a camera of the finder computing device at the QR code to read a URL and then causing a web browser on the finder computing device to access the URL. The web browser may then display a web page or form associated with the identifier. The web page may include a “call courier” button or similar user-actuatable control.

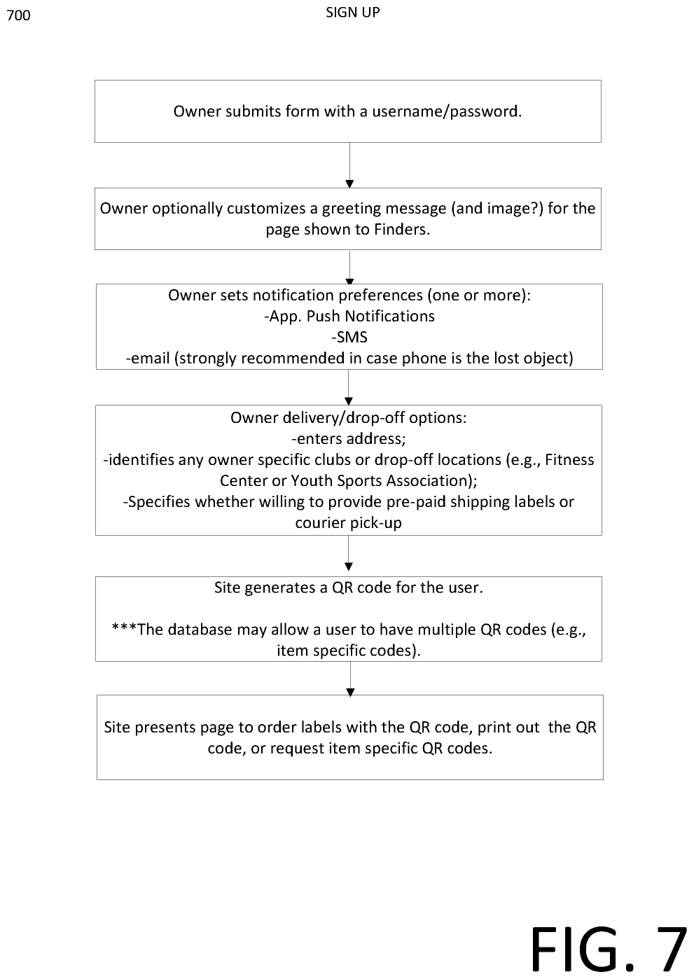

FIG. 7 is a flowchart illustrating an example process 700 for signing up (or registering) for an account in accordance with implementations described herein. In this process, an owner sets preferences and generates an identifier associated with the owner's account.

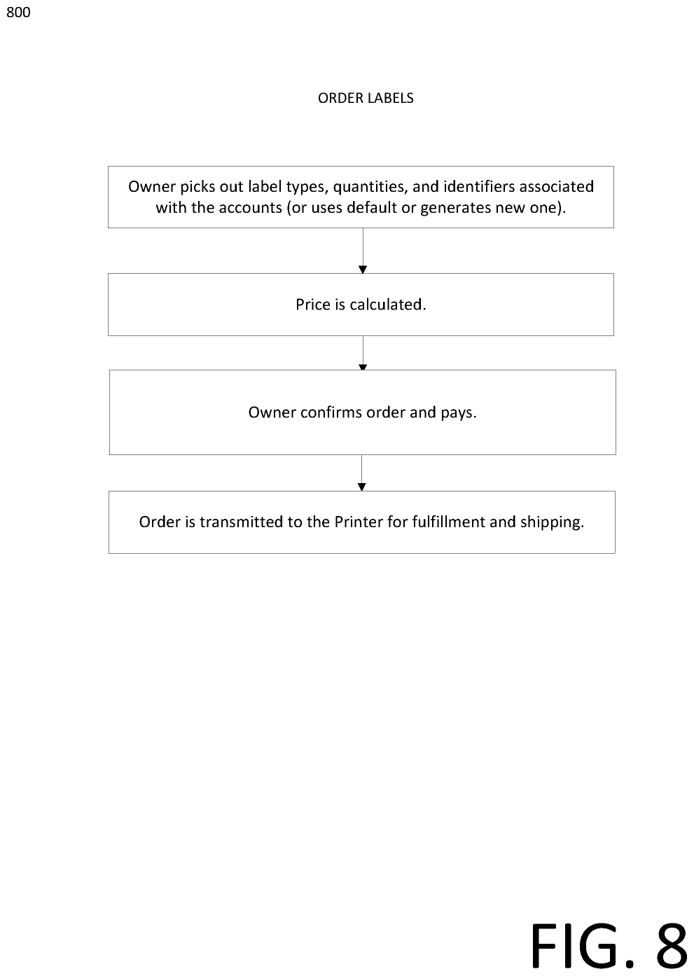

FIG. 8 is a flowchart illustrating an example process 800 for ordering labels (or other identifiers) in accordance with implementations described herein.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

What is claimed is:

1. A method comprising:
receiving an image of an identifier associated with an object;
accessing a messaging interface based on the identifier;
receiving message content via the messaging interface; and
transmitting the message content to an owner account associated with the identifier.
